(19) United States
(12) Patent Application Publication
(10) Pub. No.: US 2005/0091342 A1
(43) Pub. Date: Apr. 28, 2005

(54) Method, system, and storage medium governing management of object persistence

(75) Inventors: Jeffrey A. Frey, New Paltz, NY (US); Timo J. Salo, Cary, NC (US); Christopher P. Vignola, Port Jervis, NY (US)

Correspondence Address: CANTOR COLBURN LLP, 55 Griffin Road South, Bloomfield, CT, 06002, US

(73) Assignee: INTERNATIONAL BUSINESS MACHINES CORPORATION, ARMONK, NY (US)

(21) Appl. No.: 10/675,456

(22) Filed: Sep. 30, 2003

(51) Int. Cl. G06F 15/16

(52) U.S. Cl. 709/219; 709/217; 709/218

(57) ABSTRACT

An exemplary embodiment of the invention relates to a method, system, and storage medium for governing management of object persistence in a hosting environment. The system includes a host system in communication with a data repository and a plurality of access intent policies stored in the data repository, which define rules for specifying data access and data consistency semantics compatible with variant target back end systems associated with said host system. Client systems are in communication with the host system and receive applications services from the host system. The access intent policies include attributes comprising a readAhead attribute, access types; collection access, and pessimisticUpdateHint attribute. The system also includes a link to at least one of the client systems. The host system provides access to the access intent policies to the client systems over a communications link.

### BACKGROUND

The present invention relates generally to web hosting services, and more particularly, the present invention relates to a method, system, and storage medium for governing management of object persistence in an application hosting environment.

Building and deploying Web-based enterprise applications online has been made possible through application hosting environments such as Microsoft's .NET(™) platform and Sun's Java 2 Platform Enterprise Edition(™) (J2EE). The NET and J2EE platforms include services, APIs, and protocols that allow developers to build these Web-based applications. The J2EE platform provides functions such as threading, concurrency, security, and memory management through the use of Enterprise Java Beans (EJBs).

Entity beans are server-side components that are persistent and transactional. They are used to model persistent data objects. An entity bean can manage its own persistent state in a datastore, or it can let an EJB container manage its persistent state and relationships. The latter is referred to as a container-managed persistence (CMP) entity bean. CMPs provide a standard means for implementing persistent business components and provides distributed, transactional, and secure access to persistent data.

CMP beans are persisted to a backing store, commonly a relational database. The EJB specifications developed by Sun Microsystems(™) abstract the definition of a CMP bean in such a way that no particular backing store technology is prescribed. It is the domain and province of each J2EE provider (e.g., Websphere(™)) to choose the range and type of backing stores their product will support. Further, the EJB specification specifically charges the J2EE provider with the responsibility for providing the mapping and code generation tools necessary to support CMP EJBs on the specific backing store technology/technologies supported by that provider.

Additionally, the entity bean abstraction defined in the EJB specification does not include any definition of how issues of locking and concurrency control are to be handled in the context of managing the bean's persistent state. This is left entirely up to the J2EE provider. As a consequence, there is no standard way to define locking policy, isolation level, data consistency rules, etc.

J2EE providers have historically provided crude implements to offer some control over locking and concurrency that are directed to relational backing stores. Products such as BEA WebLogic(™) and IBM Websphere(™) have allowed specification of JavaSoft JDBC(™) isolation level and Read versus Update declarative annotations on EJBs or EJB methods. JDBC refers to Java Database Connectivity, a Java API that enables Java programs to execute SQL statements.

These solutions, however, suffer various drawbacks. For example, they address only relational (JDBC) backing stores, suffer from inconsistent semantics (i.e., the use of isolation level is problematic because different JDBC vendors manage locks differently from one another given a specific isolation level), and existing solutions have no relationship to a locking model (optimistic/pessimistic).

What is needed therefore, is a way to define and manage locking and concurrency control issues for use in an application hosting environment.

### SUMMARY

An exemplary embodiment of the invention relates to a method, system, and storage medium for governing management of object persistence in a hosting environment. The system includes a host system in communication with a data repository and a plurality of access intent policies stored in the data repository, which define rules for specifying data access and data consistency semantics compatible with variant target back end systems associated with said host system. Client system are in communication with the host system and receive applications services from the host system. The access intent policies include attributes comprising a readAhead attribute, access types; collection access, and pessimisticUpdateHint attribute. The system also includes a link to at least one of the client systems. The host system provides access to the access intent policies to the client systems over a communications link.

### BRIEF DESCRIPTION OF THE DRAWINGS

Referring now to the drawings wherein like elements are numbered alike in the several FIGURES:

FIG. 1 is a block diagram illustrating a system upon which the access intent policy system is implemented in an exemplary embodiment;

FIG. 2 is a graphical representation of a sample read ahead hint attribute expressed as a series of access paths that are created utilizing the access intent policy system in an exemplary embodiment;

FIG. 3 illustrates seven predefined access intent policies created via the access intent policy system in an exemplary embodiment;

FIG. 4 illustrates data logic decisions exercised when a CMP entity's persistent state is loaded from DB2 in an exemplary embodiment;

FIG. 5 illustrates the effect of closing a relational database cursor upon reading the data in an exemplary embodiment;

FIG. 6. Illustrates data logic decisions exercised when a CMP entity's persistent state is stored to DB2 in an exemplary embodiment; and

FIG. 7 is a flowchart describing the implementation of the access intent policy system in an exemplary embodiment.

### DETAILED DESCRIPTION

The disadvantages of the aforementioned solutions are overcome by the access intent policy system of the invention. The access intent policy system provides a higher-level abstraction by which data consistency rules are expressed. This abstraction is organized in a policy definition referred to as “access intent.” The access intent policy specifies data access and consistency rules that are agnostic to any particular back end technology such that the rule semantics expressed through an access intent policy can be mapped to an arbitrary back end. While the access intent policy system is described herein with respect to a J2EE hosting environment, it will be understood that any environment in which business logic and data logic are abstracted from one another and where the data logic is provided through the environment that hosts the business logic may be employed by the access intent policy system.

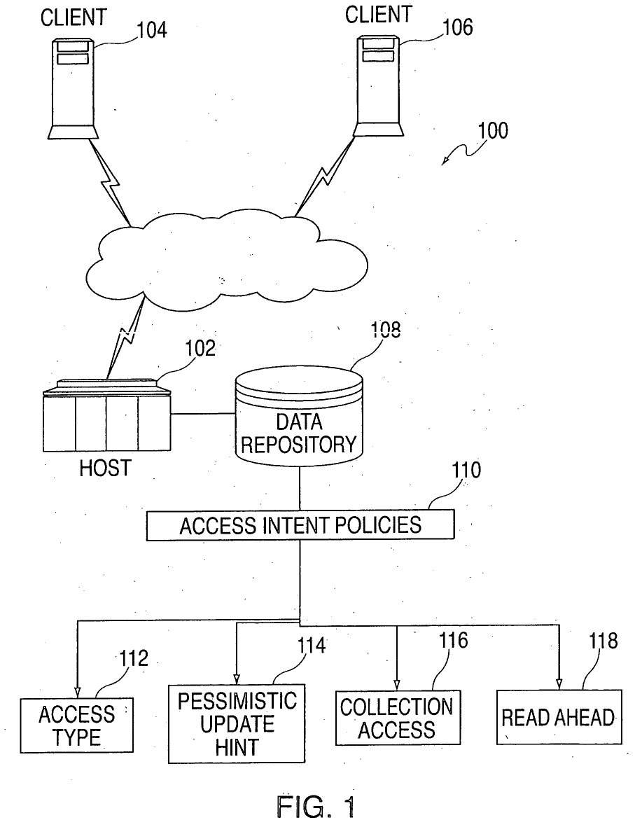

The system 100 of FIG. 1 includes a host system 102 representing a J2EE provider. Host system 102 includes a high-powered multi-processor computer that is in communication with one or both of client systems 104, 106 over a communications network such as the Internet. Host system 102 includes a data repository 108 which may be an internal component of host system 102 or may be an external component that is logically addressable to host system 102. Data repository 108 stores access intent policies for use in implementing the invention as described further herein.

Client systems 104, 106 refer to server systems operated by web developer professionals for building and managing web-based applications. Client systems 104, 106 communicate with host system 102 as recipients of J2EE services provided by host system 102.

Host system 102 executes the access intent policy system that defines policies or rules for specifying data access and consistency rules compatible with any back end technology.

The access intent policy system is applied to persistent objects such as entity beans (EJBs) with container-managed persistence (CMP). An EJB with CMP is also referred to herein as a CMP entity. The access intent policy system is further described herein with respect to an environment that utilizes relational database (RDB) technology such as IBM's DB2(™) as the backing mechanism for storing the persistent state of the CMP entity. RDB technology is accessed from the Java program through the Java Database Connectivity (JDBC) API. In a preferred embodiment, the access intent policy system utilizes a deployment scheme that includes generation of data access logic that carries out the mapping operations between the CMP entity's persistent fields and the underlying database fields that are used to store the EJB's persistent state.

Access intent policies 110 are stored in data repository 108. These policies 110 are defined by the access intent policy system and are implemented as a set of access intent attributes 112-118 as described below.

Access type attribute 112. The access type attribute specifies whether the concurrency control scheme used to select and update the EJB in the current transaction should be pessimistic or optimistic. The access type also specifies whether the EJB will be read or updated. Pessimistic indicates that a database lock is held from the time the data is read from the database until the end of the current transaction. Optimistic indicates that the data is locked with a shared lock when read, then the lock is released and not held for the remainder of the transaction. The original field values are saved when read and will be used during the update phase. When and if the EJB is to be updated within the transaction, the persistent state is written back to the database at the end of the transaction with an over-qualified update. An over-qualified update is an SQL update with the EJB's persistent fields specified in the WHERE clause of the SQL UPDATE statement. The update is said to be over-qualified because more fields than the primary key are used to locate the record that is the target of the update. The fully formed WHERE clause is also called a query predicate. The effect of the over-qualified query predicate is to ensure that the target record will be located if, and only if, it has not changed since the time it was originally read at the start of the current transaction.
There are four possible access types as indicated below.
ACCESS TYPE FUNCTION
OptimisticRead, pessimisticRead indicates the caller does not intend to drive an update method on the entity EJB
OptimisticUpdate, pessimisticUpdate indicates the caller intends to drive update methods on the entity bean.

PessimisticUpdateHint attribute 114. PessimisticUpdateHint attribute 114 is specified in conjunction with pessimisticUpdate and further qualifies the required behavior of the pessimisticUpdate. This attribute 114 is further defined as one of three elements: noCollision, exclusive, and promote. NoCollision specifies that the application will have no row collisions by design. Exclusive specifies that the application requires exclusive access to the database rows. Promote refers to a value that indicates the caller wants to access the EJB as if to read it only, but have the option to update it if necessary.

Collection access attribute 116. This attribute specifies whether the application will access the EJBs returned by a multi-object finder serially (i.e., one after the other without going back), or randomly. This hint is used to influence the cursor management scheme used by the EJB persistence machinery.

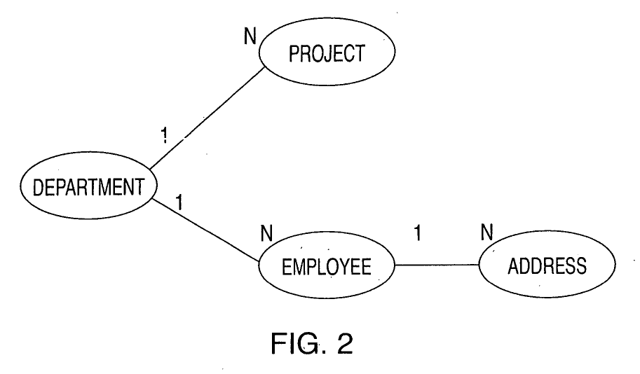

Read ahead attribute 118. For entities that have container managed relationships (CMRs), this attribute specifies which related object should also be read when a multi-object finder is driven. CMR is a component of the EJB 2.0 specification. The read ahead hint is specified as a series of access paths through a relationship graph. A sample relationship graph is shown in FIG. 2 and is expressed as ‘Department.Project; Department.Employee.Address’.

CMP entities' function sets are generated with additional query functions that reflect the various paths available for read ahead optimization. These additional query functions are built based upon container-managed relationships.

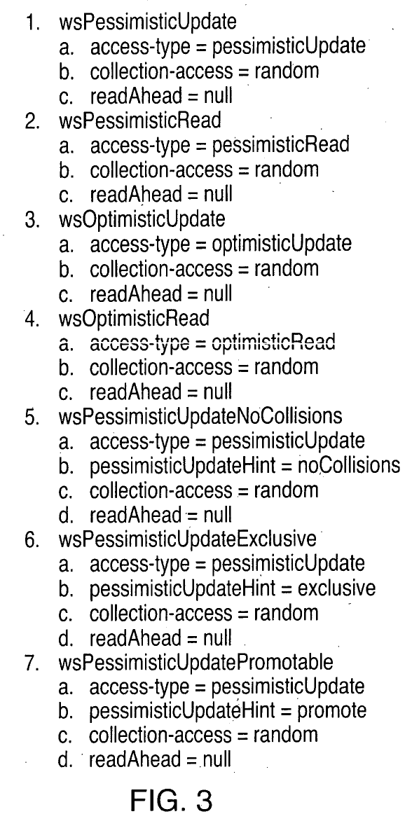

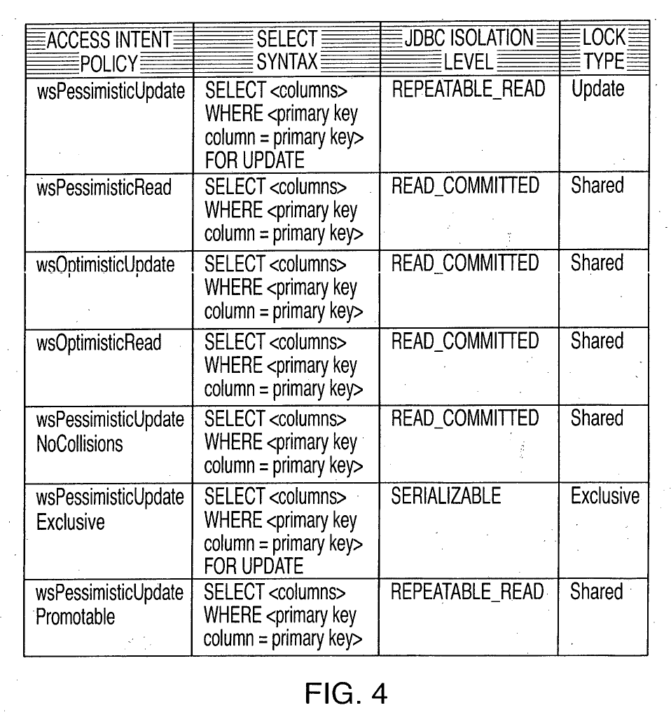

The access intent hints 112-118 may be combined to form access intent policies 110. In a preferred embodiment, seven predefined access intent policies 110 are provided by the access intent policy system as illustrated in FIG. 3. These access intent policies are formed by combining specific combinations of the access intent attributes. The access intent policy system further provides the ability to define additional access intent policies as well as add back end and platform specific ‘hints’ to improve the quality of the code generation stage. Thus, arbitrary policies are possible, by combining the specifiers or attributes in new ways. In a preferred embodiment, the access intent policy system maps the access intent policy system to SQL statements and JDBC isolation levels as shown in FIGS. 4-6. While the mapping illustrated in FIGS. 4-6 is described with respect to a DB2(™) environment, it will be understood by those skilled in the art that mappings to other RDBs and non-RDB backing stores are possible as well.

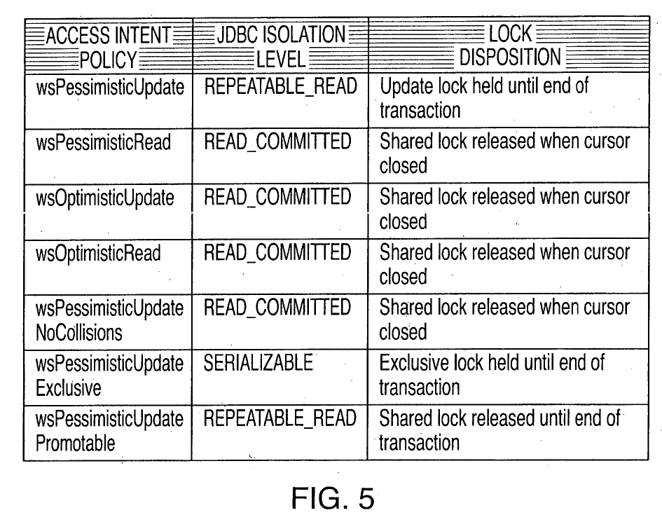

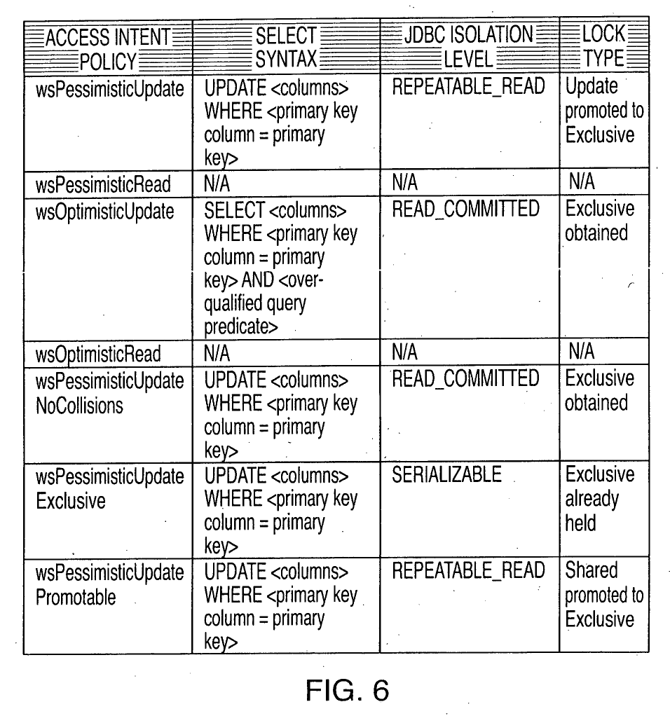

FIG. 4 illustrates the data logic decisions exercised when CMP entity's persistent state is loaded from DB2. In a preferred embodiment, the RDB cursor is closed after the data has been read, the effect of which is illustrated in FIG. 5. FIG. 6 illustrates the data logic decisions exercised when CMP entity's persistent state is stored in DB2(™).

The access intent policy system further allows new access intent policies to be created by templating the predefined policies then adding, subtracting, or modifying the specifiers. The result is a new policy, with a new name. For example, if an application was designed to operate on the Department CMP and its related EJBs, Employee and Address, defined as a CMR (as described above) and if the application expects to update at least the Department CMP, and intends to do so using an optimistic concurrency pattern, then the following new access intent policy named as ‘DepartmentDeepReadOptimisticUpdate,’ would be comprised of the attributes: access-type=optimisticupdate; collection-access=random; and readAhead=Department.Employee.Address.

The access intent policy system allows an EJB developer to map a CMP's persistent fields to database table fields through the use of tooling. A J2EE application developer may assign an access intent policy to each of the EJBs used by the application through tooling as well.

The preferred embodiment's deployment tooling generates data access logic for CMP entities in accordance with the assigned access intent policy. For example, given the DepartmentDeepReadOptimisticUpdate policy, described above, the data access logic would be included in the code generated by the deployment tooling as provided below. To support loading the persistent state:

SELECT <department fields> FROM Departments

WHERE <department primary key> = <department
primary key value>
INNER JOIN <employee fields> FROM Employees
WHERE <employee primary key>
= <department secondary key value from departments table>

INNER JOIN <address fields> FROM Address
WHERE <address primary key>
= <address secondary key value from address table>

The purpose of the read-ahead hint 118 is to instruct the deployment tooling to generate code that reads the persistent state for multiple, related EJBs in a single SELECT statement. This improves performance by reducing the number of database interactions required by the application. To support updating the persistent state:

SELECT <department fields> TO Departments

WHERE <department primary key> = <department
primary key value>
AND <optimistic query predicate field 1> =

<optimistic query predicate field 1 value>

AND <optimistic query predicate field 2> =

<optimistic query predicate field 2 value>

. . .
AND <optimistic query predicate field n> =

<optimistic query predicate field n value>

Note that the development tooling provided by the preferred embodiment further allows the EJB developer to configure the fields necessary to define the optimistic query predicate for a CMP. The fields are chosen in such as way as to ensure that no updatable fields of the CMP entity changed since the persistent state of the CMP was loaded. If any fields had changed, the UPDATE statement would fail to locate the target record.

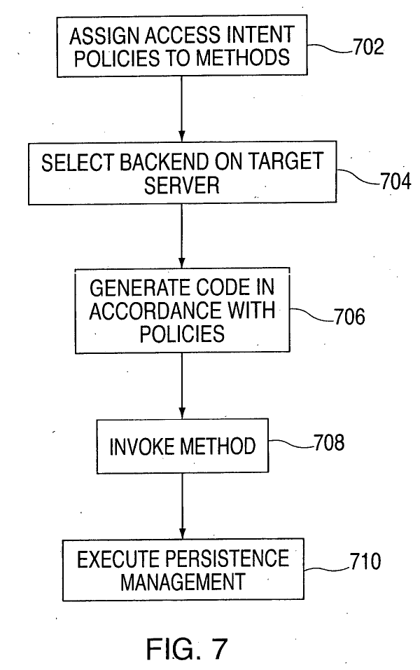

The process of implementing the access intent policy system is described in FIG. 7. At step 702, access intent policies 110 are assigned to individual EJB methods. An EJB method is an object method and refers to a discrete, callable unit of program logic that performs some action against the EJB. It is the organizational basis by which program logic is organized in the context of an EJB. During the deployment process, a specific back end available on the target J2EE server 104, 106 is selected for this EJB at step 704. At step 706, code is generated specifically for that back end in accordance with assigned policy definitions. Code may be generated by tooling that has been provided with the J2EE System or by the J2EE System provider. This represents what the J2EE System refers to as the Deployment phase.

The method on that EJB is invoked at step 708. The persistence management is carried out by the generated code based on the policy assigned to that method at step 710. For example, assuming a relational database backing mechanism is used, SELECT and UPDATE statements are generated to support the load and storage of the EJB's persistent state. An EJB is loaded upon ‘first touch’. ‘First touch’ means the point in time at which the first method invocation occurs on the EJB in a new transaction context. An access intent policy is assigned to the method. The first method is invoked in a transaction on a particular EJB, then, the effective access intent policy used on that EJB in that transaction is determined.

The access intent policy system provides a mechanism for expressing access intent by associating an abstract policy with an object, the attributes of which express the manner in which the object will be accessed. The access intent policy governs the selection of locking scheme, data access patterns, and cache management which allows for the management of the persistent state of the object.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A system for governing management of object persistence in a hosting environment, comprising:
a host system in communication with a data repository;
a plurality of access intent policies stored in said data repository, said access intent policies defining rules operable for specifying data access and data consistency semantics compatible with variant target back end systems associated with said host system, wherein client systems receive application hosting services from said host system;
wherein said access intent policies include attributes comprising:
access type attributes;
Readahead attributes;
collection access attributes; and
pessimisticupdatehint attributes; and
a link to at least one of said client systems;
wherein said host system provides access to said plurality of access intent policies to said at least one of said client systems over a communications link.

2. The system of claim 1, further comprising a Java 2 Enterprise Edition environment associated with said host system, wherein said host system provides access to said plurality of access intent policies to said at least one of said client systems via said Java 2 Enterprise Edition environment.

3. The system of claim 2, wherein said access type attributes include an optimisticRead attribute and a pessimisticRead attribute operable for specifying whether an update method will be driven on a persistent object.

4. The system of claim 3, wherein said access type attributes further include an optimisticUpdate attribute and a pessimisticUpdate attribute operable for specifying whether an update method will be driven on a persistent object.

5. The system of claim 2, wherein said readAhead attribute specifies which related object in a container-managed relationship will be read when a multi-object finder is driven.

6. The system of claim 2, wherein said collection access attribute specifies whether an application will access a persistent object returned by a multi-object finder serially or randomly.

7. The system of claim 6, wherein said persistent object is an enterprise Java bean.

8. The system of claim 6, wherein said collection access attribute is used to implement a cursor management scheme.

9. The system of claim 2, wherein said pessimisticUpdateHint attribute further comprises a noCollision element operable for specifying that an application will have no row collisions.

10. The system of claim 2, wherein said pessimisticUpdateHint attribute further comprises an exclusive element operable for specifying that an application requires exclusive access to a database row.

11. The system of claim 2, wherein said pessimisticUpdateHint attribute further comprises a promote element operable for specifying whether a persistent object has read only access with an option to update said persistent object if necessary.

12. The system of claim 1, wherein at least one of said variant target back end systems employs a relational database.

13. The system of claim 1, wherein said at least one of said client systems is a server operated by a web developer, said web developer building and managing a web-based application via at least one of said plurality of access intent policies.

14. A method for governing management of object persistence in an application hosting environment via an access intent policy system, comprising:
assigning an access intent policy to a method, said access intent policy including attributes comprising:
an access types;
a pessimisticUpdateHint attribute;
a collection access attribute; and
a readAhead attribute;
associating a target back end system with said method;
generating code specific to said target back end system based upon assigned access intent policy;
invoking said method for a transaction; and
implementing persistence management via said code.

15. The method of claim 14 wherein said application hosting environment is a Java 2 Enterprise Edition architecture.

16. The method of claim 15, wherein said access intent policy is predefined based upon a selected group of said attributes.

17. The method of claim 15, wherein said access intent policy is customized by selecting unique combinations of said attributes.

18. A storage medium comprising machine-readable computer program code for governing management of object persistence in a hosting environment, said storage medium including instructions for causing a computer to implement a method, comprising:
assigning an access intent policy to a method, said access intent policy including attributes comprising:
an access types;
a pessimisticUpdateHint attribute;
a collection access attribute; and
a readAhead attribute;
associating a target back end system with said method;
generating code specific to said target back end system based upon assigned access intent policy;
invoking said method for a transaction; and
implementing persistence management via said code.

19. The storage medium of claim 18 wherein said application hosting environment is a Java 2 Enterprise Edition architecture; wherein said application hosting environment provides Java 2 Enterprise Edition services to a client system.

20. The storage medium of claim 19, wherein said access intent policy is predefined based upon a selected group of said attributes.

21. The storage medium of claim 19, wherein said access intent policy is customized by selecting unique combinations of said attributes.
